(19) United States
(12) Patent Application Publication
(10) Pub. No.: US 2020/0208446 A1
(43) Pub. Date: Jul. 2, 2020

(54) Door Handle Cable Lock

(71) Applicant: Phillip Turner, Great Cacapon, WV (US)

(72) Inventor: Phillip Turner, Great Cacapon, WV (US)

(21) Appl. No.: 16/726,984

(22) Filed: Dec. 26, 2019

Related U.S. Application Data
(60) Provisional application No. 62/785,516, filed on Dec. 27, 2018.

(51) Int. Cl. E05C 17/36; E05B 17/20

(52) U.S. Cl. CPC E05C 17/36; E05B 17/2084

(57) ABSTRACT

A door handle cable lock including a first cable with a first loop at a first end. The first loop is sized to fit around a door handle. The first cable has a second loop at a second end. The second loop is attached to a first connector. The first connector is configured to connect to a wall connector. The wall connector is connected to the wall adjacent to the door. The cable is of a length that will allow it to be placed over the doorknob and for the door not to be capable of opening. A second cable is attached to the wall connector and the first connector. The second connector acts as a back-up connector if the first connector malfunctions.

### CROSS REFERENCE TO RELATED APPLICATIONS

This application claims the benefit of U.S. Provisional Application No. 62/785,516 filed on Dec. 27, 2018. The above identified patent application is herein incorporated by reference in its entirety to provide continuity of disclosure.

### BACKGROUND OF THE INVENTION

The present invention relates to door security during an emergency situation. More particularly, the present invention provides a door locking device that will add extra security to a door.

Unfortunately, the world experiences acts of senseless violence every day. These acts are designed to hurt and or cause fear and they are aimed at civilian targets as a means of increasing those desired effects. Many civilian buildings are equipped with locking doors. In some cases, security teams have been hired to keep buildings safe. Even with all of the new and improved security there are still issues.

Individuals may still feel helpless. Further, even with all of the new security measures that are being taken everyday terrorists still find a way around the security and to attempt their plans, on occasion. In some instances, a simple door lock may not be enough. Traditional doors can have weak handles due to the ability to save costs. This means that a door can be forced open even when closed and locked. In some instances, corporate doors do not even have deadbolts only small locks on the handles.

Consequently, there is a need in for an improvement in the art of door security. The present invention substantially diverges in design elements from the known art while at the same time solves a problem many people face when quickly acting to secure an area in an emergency situation. In this regard the present invention substantially fulfills these needs.

### SUMMARY OF THE INVENTION

The present invention provides a door handle cable lock wherein the same can be utilized for providing convenience for the user when using a door lock to add extra security to a door. The door handle cable lock includes a length of cable having a first end and a second end. The cable has a first loop at the first end and a second loop at the second end. The second loop is connected to a first connector.

Another object of the door handle cable lock is to have a second cable, wherein the second cable is connected to the first connector at one end.

Another object of the door handle cable lock is to have another end of the second cable is configured to be attached to a wall connector.

Another object of the door handle cable lock is to have the first connector is configured to attached to a wall connector.

Another object of the door handle cable lock is to have the first connector be a clevis hook.

Another object of the door handle cable lock is to have at least one cable clip, wherein the cable clip holds the first end of the cable to a middle section of the cable creating the first loop.

Another object of the door handle cable lock is to have at a second cable clip, wherein the cable clip holds the second end of the cable to a middle section of the cable creating the second loop.

Another object of the door handle cable lock is to have the first cable be not long enough to allow the door to open.

Another object of the door handle cable lock is to have a wall connector attached to a door jamb, wherein the wall connector is attached to the first connector.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the door handle cable lock.

FIG. 2 shows an exploded view of an embodiment of the individual parts for the door handle cable lock.

FIG. 3 shows an in-use view of an embodiment of the door handle cable lock.

### DETAILED DESCRIPTION OF THE INVENTION

Reference is made herein to the attached drawings. Like reference numerals are used throughout the drawings to depict like or similar elements of the door handle cable lock. For the purposes of presenting a brief and clear description of the present invention, a preferred embodiment will be discussed as used for the door handle cable lock. The figures are intended for representative purposes only and should not be considered to be limiting in any respect.

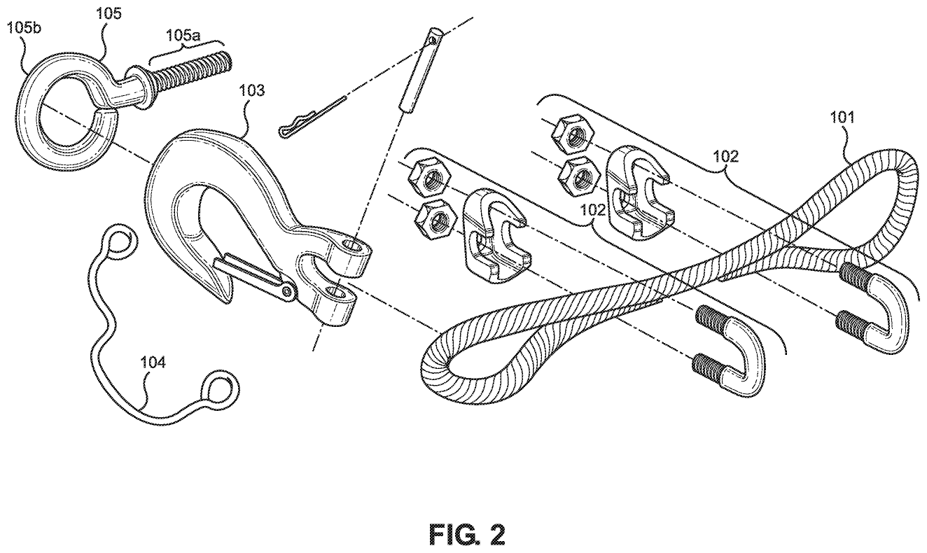

Referring now to FIG. 2, there is shown an exploded view of an embodiment of the individual parts for the door handle cable lock. The door handle cable lock includes a first cable 101. In one embodiment the first cable 101 is braided steel. In another embodiment the first cable 101 is made from another suitable material. In a further embodiment the first cable 101 has a coating on it. In one embodiment the coating is rubber. In another embodiment the coating is plastic.

The door handle cable lock further includes at least one cable clip 102. In one embodiment the cable clip 102 is a crimp style clip. In another embodiment the cable clip 102 is a multipart clip. The cable clip 102 will include a bent rod with threads on both ends, a clip adjuster, and two nuts to screw onto the threaded ends. When the nuts are screwed to the threaded ends the clip adjuster will tighten holding the cable.

The door handle cable lock further includes a first connector 103. In one embodiment the first connector 103 is a carabiner. In another embodiment the first connector 103 is a weldless chain link. In a different embodiment the first connector 103 is a hook type connector. In some embodiments the hook has a spring-loaded lock that will close the hook such that an item will stay within the hook area.

In some embodiments a second cable 104 is included with the door handle lock. In one embodiment the second cable 104 is thinner than the first cable. The second cable 104 is configured to have a loop at the first end and a loop at the second end 104. In one embodiment the loop at the second end is adjustable in size. In one embodiment the second cable 104 is braided steel. In another embodiment the second cable 104 is a solid cable. In a third embodiment the second cable 104 is another suitable material makeup.

The system for the door handle cable lock includes a wall connector 105. The wall connector 105 is designed to connect securely to the wall adjacent to the door and to the first connector 103. In one embodiment the wall connector 105 has a threaded portion 105a and a loop portion 105b. This will allow the wall connector 105 to be securely screwed into the wall and then to have the first connector 103 secured thereto.

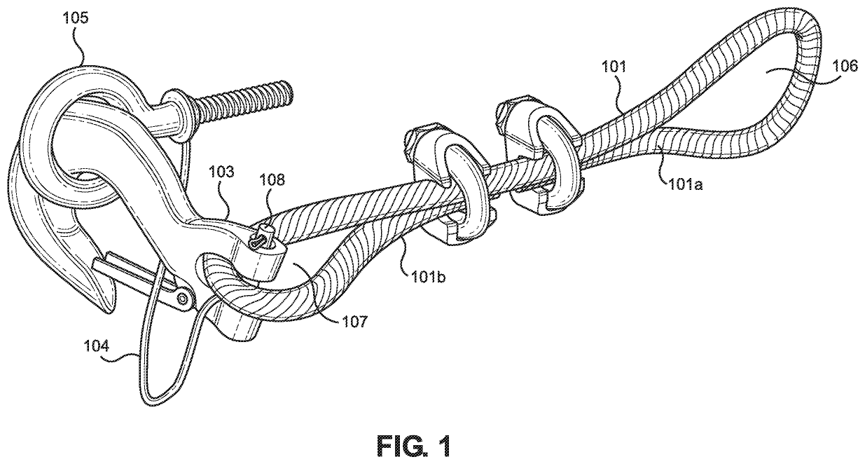

Referring now to FIG. 1, there is shown a perspective view of an embodiment of the door handle cable lock. The door handle cable lock has a loop 106 created in the first cable 101 at a first end 101a. The loop 106 is configured to fit over a door handle or knob. In one embodiment the loop 106 is a fixed loop. In another embodiment the loop 106 has the ability to slide closed.

A second side 101b of the first cable 101 will be attached to the first connector 103. In one embodiment the second side 101b will be secured to the first cable 101 to create a second loop 107. This second loop 107 will then be able to attach to the first connector 103. In some embodiments the first connector 103 will have a pin 108 placed through the first connector 103 and the second loop 107. This will secure the first cable 101 to the first connector 103.

The first connector 103 is configured to be connected to the wall connector 105. In one embodiment the first connector 103 is removably secured to the wall connector 105. In another embodiment the first connector 103 is permanently attached to the wall connector 105. In some embodiments there is further a second cable 104 attached to the wall connector 105. The second cable 104 is a backup in case the first connector 103 becomes unattached. The second cable 104 is further connected to at least the first connector 103. In one embodiment the second cable 104 is also connected to the first cable 101. This will act as an additional safety measure.

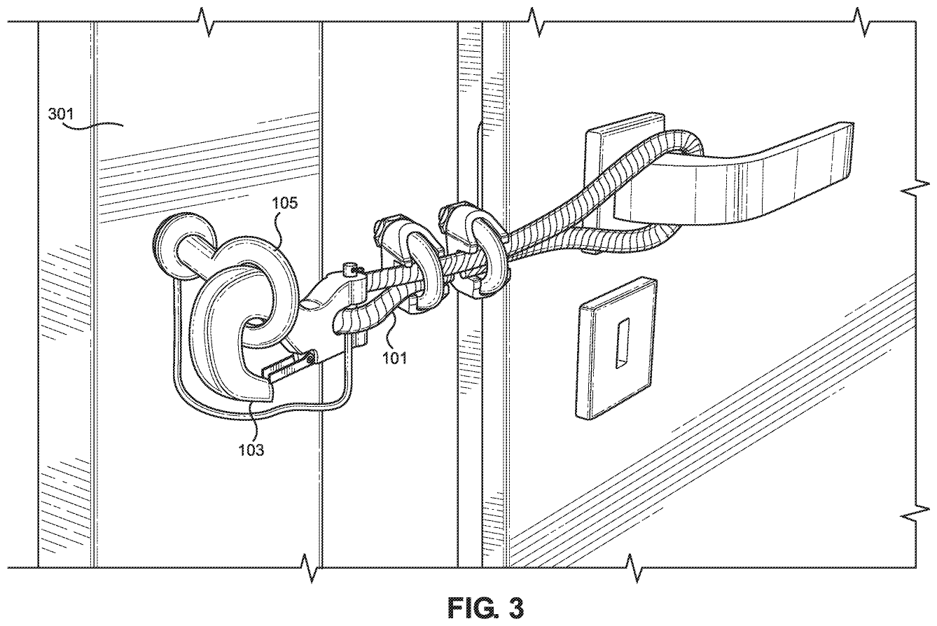

Referring now to FIG. 3, there is shown an in-use view of an embodiment of the door handle cable lock. In use the wall connector 105 is attached to the wall adjacent to the door. In one embodiment the wall connector 105 is attached to a wall stud. In another embodiment the wall connector 1.05 is connected to the door jamb 301. The first connector 103 will then be attached to the wall connector 105. The loop of the first cable 101 is placed around the doorknob. This will prevent the door from fully opening and allowing an individual to enter the room.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A door handle cable lock, the lock comprising:
a length of cable having a first end and a second end;
wherein the cable has a first loop at the first end and a second loop at the second end;
wherein the second loop is connected to a first connector.

2) The door handle cable lock of claim 1, further comprising a second cable, wherein the second cable is connected to the first connector at one end.

3) The door handle cable lock of claim 2 wherein another end of the second cable is configured to be attached to a wall connector.

4) The door handle cable lock of claim 1, wherein the first connector is configured to be attached to a wall connector.

5) The door handle cable lock of claim 1, wherein the first connector is a clevis hook.

6) The door handle cable lock of claim 1, further comprising at least one cable clip, wherein the cable clip holds the first end of the cable to a middle section of the cable creating the first loop.

7) The door handle cable lock of claim 6, further comprising at a second cable clip, wherein the cable clip holds the second end of the cable to a middle section of the cable creating the second loop.

8) The door handle cable lock of claim 1, wherein the first cable is not long enough to allow the door to open.

9) A door handle cable lock system, the system comprising:
a length of cable having a first end and a second end;
wherein the cable has a first loop at the first end and a second loop at the second end;
wherein the second loop is connected to a first connector;
a wall connector attached to a door jamb, wherein the wall connector is attached to the first connector.

10) The door handle cable lock system of claim 9, further comprising a second cable, wherein the second cable is attached to the first connector and the wall connector.

11) The door handle cable lock system of claim 9, wherein the first connector is a clevis hook.

12) The door handle cable lock system of claim 9, further comprising at least one cable clip, wherein the cable clip holds the first end of the cable to a middle section of the cable creating the first loop.

13) The door handle cable lock system of claim 12, further comprising at a second cable clip, wherein the cable clip holds the second end of the cable to a middle section of the cable creating the second loop.

14) The door handle cable lock system of claim 9, wherein the first loop is wrapped around a door handle.

15) The door handle cable lock system of claim 14, wherein the cable not allow the door to open.
